(19) United States
(12) Patent Application Publication
(10) Pub. No.: US 2014/0379362 A1
(43) Pub. Date: Dec. 25, 2014

(54) CLINICAL TRIAL PARTICIPANT REIMBURSEMENT SYSTEM

(71) Applicant: TCN Technologies, LLC, Needham, MA (US)

(72) Inventors: Joan F. Bachenheimer, Hull, MA (US); Michael S. Johnson, Weymouth, MA (US); Matthew L. Kibby, Sharon, MA (US)

(21) Appl. No.: 14/295,082

(22) Filed: Jun. 3, 2014

Related U.S. Application Data
(60) Provisional application No. 61/837,741, filed on Jun. 21, 2013.

(51) Int. Cl. G06F 19/00; G06Q 50/24; G06Q 20/10

(52) U.S. Cl. CPC G06F 19/363; G06Q 20/105; G06Q 50/24
USPC 705/2

(57) ABSTRACT

A clinical trial participant reimbursement system relies on a separate a patient tracking system having a patient database with a participant record unique identification string for each patient of a plurality of patients configured in such a way that maintains patient anonymity and does not itself convey patient identifying information. The clinical trial participant reimbursement system creates an association between the participant record unique identification string and a reloadable payment card unique identification string for a payment card assigned to each participant for receiving reimbursement payments. The payment card itself can be issued without being coupled to the patient's bank account, and by loading a payment card there is no need to issue checks with the patient's name (i.e., patient identifying information) thereon. The payment card can be issued with a zero balance, a pre-determined balance, or a customized balance indicated by the system and set at the time of the card activation.

### RELATED APPLICATION

This application claims priority to, and the benefit of, co-pending U.S. Provisional Application No. 61/837,741, filed Jun. 21, 2013, for all subject matter common to both applications. The disclosure of said provisional application is hereby incorporated by reference in its entirety.

### FIELD OF THE INVENTION

The present invention relates to a clinical trial participant reimbursement system, and more particularly to a system and method for effecting clinical trial participant reimbursement without requiring patient identifying information to be conveyed to an entity outside of the control of a clinical trial patient visit location.

### BACKGROUND OF THE INVENTION

In carrying out clinical research for pharmaceuticals, medical devices, and biologics, there are many electronic data collection and operational support systems known as clinical trial management systems, patient recruitment management systems, or electronic data capture systems. Generally, in the patient recruitment process a company with a product, such as, but not limited to, a pharmaceutical company with a new drug, or a medical device company with a new medical device, has studies (e.g., trials) that require completion to a degree of regulatory satisfaction. The company contracts with investigational sites for the completion of the studies, while the investigational sites are responsible for recruiting patients, having the studies completed, and reporting results of the studies. Part of the conventional clinical trial process includes the reimbursement of patients participating in the clinical trial for expenses incurred in being a participant. Such expenses can include, e.g., travel, mileage, food, lodging, and the like.

There are several methodologies currently utilized to reimburse clinical trial participants. One set of approaches involves collecting different forms of patient identifying information (e.g., name, social security number, bank account information, or the like), and then providing reimbursement through methods such as direct deposits into a patient's bank account, repeated issuance of conventional checks made out to the patient's name, or the issuance of a debit card linked to a personal banking account of the patient, which can be re-loaded. However, such methodologies require the collection of patient identifying information, such as name, social security number, bank account numbers, or the like, such that there is no anonymity maintained by the patient participant with respect to the clinical trial management entities. That is, the patient identifying information must be shared with entities outside of the doctor's office or clinical trial location where the patient is making in-person visits to receive treatment or to have physiological or related measurements taken in order to enroll in reimbursement mechanisms. The other entities include third party companies that participate in the clinical trials and those that coordinate the reimbursement payments and the banking institutions they engage.

To avoid the requirement that patient identifying information be shared with the clinical trial management entities, other methodologies include pre-loading of cash cards with set amounts of monetary value. The pre-loaded cards are shipped to a clinical trial location (e.g., doctor's office), where the local staff must securely store the cards and distribute them to clinical trial patient participants in the appropriate quantities. While this method does not require the clinical trial management entity, or the third party company that issues the payment card, to have the patient identifying information, this method requires extra security measures to be taken with respect to the storing and handling of the pre-loaded cash cards (which are, essentially, cash). It is also difficult to track reimbursements to patients, and lost cards cannot be easily replenished. Further, it is difficult to reimburse variable or customized amounts with pre-loaded cash cards.

### SUMMARY

There is a need for a clinical trial participant reimbursement system that maintains patient anonymity with respect to the management system and any third party reimbursement system, while also enabling financial tracking measures and accountability. The present invention is directed toward further solutions to address this need, in addition to having other desirable characteristics.

In accordance with an embodiment of the present invention, a clinical trial participant reimbursement system includes a patient recruitment management system having a patient recruitment management system database storing each of a plurality of reloadable payment card unique identification strings in association with a different participant record unique identification string, the participant record identification string maintaining patient anonymity by not containing a combination of string characters that communicates patient identifying information. Loading of a reloadable payment card is effected upon receipt by the patient recruitment management system of an instruction to load a reloadable payment card, the instruction only requiring the participant record unique identification string and an indication of amount.

In accordance with aspects of the present invention, the instruction to load the reloadable payment card can cause the patient recruitment management system to generate and output an instruction to a card management system, the instruction containing the reloadable payment card unique identification string associated with the participant record unique identification string and the indication of amount. The indication of amount can include a selected quantity of monetary value. Patient identifying information is not required by the patient recruitment management system to effect loading of the reloadable payment card. Patient identifying information is not required by a card management system to effect loading of the reloadable payment card.

In accordance with further aspects, the reloadable payment card can remain reloadable after having been dispatched to a participant. The reloadable payment card can be dispatched to a participant with a zero cash value, a pre-determined value, or a customized value. A clinical trial sponsor funds a financial account that supplies the reloadable payment card with money.

In accordance with an embodiment of the present invention, a clinical trial participant reimbursement system includes a patient tracking system having a patient database, the patient database storing a plurality of participant record unique identification strings, one string for each patient of a plurality of patients, the participant record unique identification string configured in such a way that maintains patient anonymity and does not itself convey patient identifying information. A patient recruitment management system has a patient recruitment management system database. A plurality of participant records are stored in the patient recruitment management system database, each participant record stored in association with the participant record unique identification string provided by the patient tracking system for each patient of the plurality of patients. A card management system has a card management system database. A plurality of reloadable payment cards are managed by the card management system. A plurality of reloadable payment card unique identification strings are stored in the card management system database, each reloadable payment card unique identification string stored in association with one of the plurality of reloadable payment cards. Within the patient recruitment management system database, each of the plurality of reloadable payment card unique identification strings is stored in association with each of the participant record unique identification strings. Loading of a reloadable payment card is effected upon receipt by the patient recruitment management system of an instruction containing only the participant record unique identification string and an indication of amount.

In accordance with aspects of the present invention, the instruction to load the reloadable payment card can cause the patient recruitment management system to generate and output an instruction to the card management system, the instruction containing the reloadable payment card unique identification string associated with the participant record unique identification string and the indication of amount. The indication of amount can include a selected quantity of monetary value. Patient identifying information may not be required by the patient recruitment management system to effect loading of the reloadable payment card. Patient identifying information may not be required by the card management system to effect loading of the reloadable payment card. The reloadable payment card can remain reloadable after having been dispatched to a participant. The reloadable payment card can be dispatched to a participant with a zero cash value, a pre-determined value, or a customized value. A clinical trial sponsor can fund a financial account that supplies the reloadable payment card with money.

In accordance with aspects of the present invention, the patient database can include a patient interactive voice response system (IVRS) database containing patient identifying information in association with each of the plurality of participant record unique identification strings. Each of the plurality of participant record unique identification strings can be configured to maintain patient anonymity.

In accordance with one embodiment of the present invention, a method of automatically effecting loading a reloadable payment card with a reimbursement amount includes a patient recruitment management system receiving an update from a patient tracking system regarding activity relating to a clinical trial participant. The patient recruitment management system automatically generates a reimbursement request instruction based on the update. The patient recruitment management system outputs the reimbursement request instruction including an amount of monetary value to a card management system.

In accordance with aspects of the present invention, the card management system can receive the reimbursement request instruction and load the amount of monetary value onto a payment card issued to the clinical trial participant.

### BRIEF DESCRIPTION OF THE FIGURES

These and other characteristics of the present invention will be more fully understood by reference to the following detailed description in conjunction with the attached drawings, in which:

FIG. 1 is a diagrammatic illustration of a clinical trial participant reimbursement, according to an embodiment of the present invention;

FIG. 2 is a diagrammatic illustration of a reimbursement card, according to one aspect of the present invention;

FIG. 3 is a flowchart illustrating an example method of implementation of the reimbursement system, according to one embodiment of the present invention; and

FIG. 4 is a flowchart illustrating an example method of implementation of the reimbursement system, according to one aspect of the present invention.

### DETAILED DESCRIPTION

An illustrative embodiment of the present invention relates to a clinical trial participant reimbursement system. The system relies on a separate patient tracking system having a patient database with a participant record unique identification string 120 for each patient of a plurality of patients. The participant record unique identification string 120 is configured in such a way that maintains patient anonymity and does not itself convey patient identifying information. That is, the participant record unique identification string 120 is a collection of, e.g., alpha-numeric characters that as combined to not, on their face, convey patient identifying information that would allow an individual to determine who a particular participant is simply by reading the string and deriving from that string who the individual is without some other, additional, information. The clinical trial participant reimbursement system creates an association between the participant record unique identification string 120 and a reloadable payment card unique identification string for a payment card assigned to each participant for receiving reimbursement payments. When a participant does something that is reimbursable by the clinical trial within which they are participating, an instruction to load the reloadable payment card is initiated at the patient interface end of the system, i.e., the doctor's office, where the patient identity is known (and from which a patient tracking database is updated). The instruction is submitted to the patient recruitment management system with only the participant record unique identification string 120 and an indication of monetary value to load onto the card (i.e., there is no patient identifying information, patient name, social security identifier, bank account information, or the like that is forwarded to the patient recruitment management system). The patient recruitment management system further conveys the order to a card management system, which loads the payment card using funds provided to the card management system by a sponsor of the clinical trial. In this way, the patient identifying information remains at the doctor's office, yet payment can be effected very quickly by reloading the patient's payment card. The payment card itself can be issued without being coupled to the patient's bank account, and by loading a payment card there is no need to issue checks with the patient's name (i.e., patient identifying information) thereon. Further, the patient recruitment management system can have information as to the reimbursement transactions and how they relate to the clinical trial being managed by the system, thus full transaction accounting and related measures required for auditing of the clinical trial process remain fully provided by the overall system. Finally, should a payment card be lost by a participant, there is a mechanism to validate its loss, check on the remaining balance, and reissue a card, without requiring the private patient identifying information.

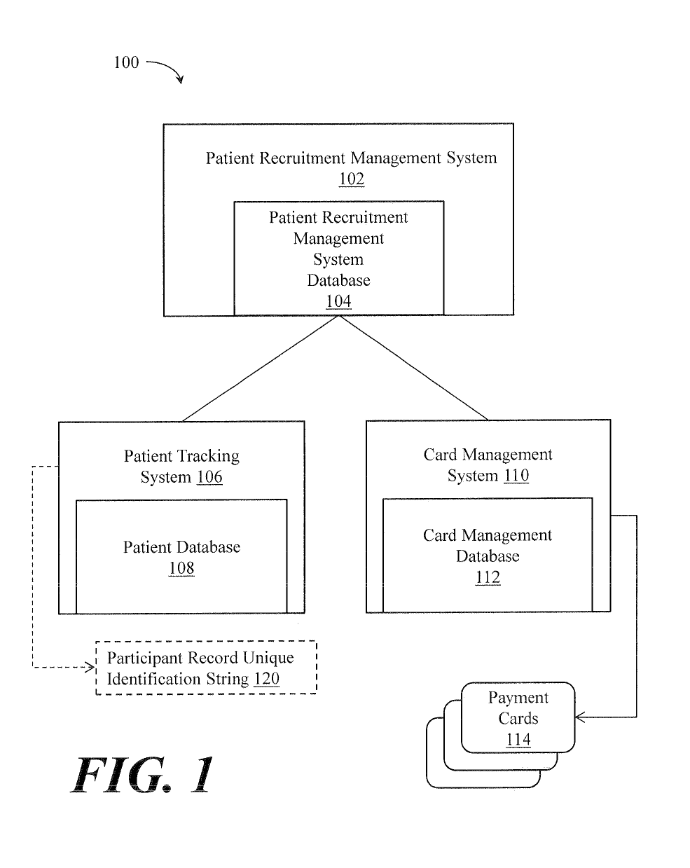

FIGS. 1 through 4, wherein like parts are designated by like reference numerals throughout, illustrate an example embodiment of a clinical trial participant reimbursement system according to the present invention. Although the present invention will be described with reference to the figures, it should be understood that many alternative forms can embody the present invention. One of skill in the art will additionally appreciate different ways to alter the parameters disclosed in a manner still in keeping with the spirit and scope of the present invention.

Turning first to FIG. 1, a clinical trial participant reimbursement system 100 includes a patient recruitment management system 102. The patient recruitment management system 102 further includes a patient recruitment management system database 104. The patient recruitment management system database 104 can be within the patient recruitment management system 102 or in communication with or accessible thereby, and there can be one or a plurality of databases that form the patient recruitment management system database 104 as would be appreciated by those of skill in the art. The clinical trial participant reimbursement system 100 further includes a patient tracking system 106 having a patient database 108 in communication therewith or accessible thereby. The clinical trial participant reimbursement system 100 also includes a card management system 110 having a card management database 112 in communication therewith or accessible thereby.

The patient recruitment management system 102 and patient recruitment management system database 104 can take many forms. Patient recruitment management systems are essentially customizable software systems used by biotech and pharmaceutical companies and researchers to manage clinical trials and all of the substantial amounts of data that corresponds with the clinical trial process. A patient recruitment management system can often manage planning, preparation, performance, and reporting of clinical trials. With respect to the patient participants, the patient recruitment management system can track actions taken, milestones, upcoming deadlines or study visits, and can often generate summary reports based on such data. Some patient recruitment management system software applications include a dashboard presentation of information to enable user interaction. The patient recruitment management system database 104 can take the form of a single database or multiple databases able to communicate therebetween, as would be appreciated by those of skill in the art.

On the tracking and report side of such systems, features that include budgeting, patient management, and government regulation compliance are often necessary. In addition, these systems should also offer good compatibility with other software systems that may feed information to the patient recruitment management system or receive information from the patient recruitment management system. As such, it is important for such systems to be able to audit reimbursement transactions for clinical trial participants.

A clinical trial will in most instances have one or more entities serving a sponsor role. The sponsor is responsible for funding the clinical trial, and often sets requirements and wants reports and summaries as to project status, budget and financials, patient management and recruitment, government compliance, and the like. In some instances a research entity will play the role of the sponsor, and in other instances the sponsor will be a corporation.

Patient recruitment management systems can take many forms, including enterprise based, cloud based, or other software as a service (SaaS) modalities, or can be based in a particular server or collection of servers as would be appreciated by those of skill in the art. All such implementations of patient recruitment management system are anticipated for use with the present invention. Patient recruitment management systems are well known in the industry generally, and as such no additional details regarding such software is needed herein.

The patient tracking system 106 having the patient database 108 can likewise take many different forms. The patient database 108 can again be a single database or multiple databases, as would be appreciated by those of skill in the art. The patient tracking system is often implemented in the form of, for example, an Interactive Voice Response System (IVRS) or Interactive Web Response System (IWRS). For purposes of clarity, the present description will refer to an “IVRS” with the intention of capturing the “voice” and “web” implementations, as well as any equivalents, such that the acronym “IVRS” is not intended to be limited to only the voice based system, but to also include the IWRS and others. An IVRS generally refers to a known technology that provides an automated or non-human form of interaction with the patient database 108. Computer or telephone keypad entry of information, voice recognition, or web input, can be utilized to interact with a database to gather information from or enter data into the database. IVRS technology often makes use of generalized recordings to convey information. An IVRS, because of its ability to interact with large quantities of participants, can also include a database and software component that maintains updated patient/participant records. In addition, some systems can also track finances including reimbursements. Such systems may have the latest contact information for patients. There may also be a local filing system or database at a patient location (i.e., doctor's office, clinical trial location) which can serve as the primary source for the most up to date information or the best way to get information out to patients or participants. However, the important feature of an IVRS is its generation and use of a unique identifier associated with each participant/patient name, as is described herein. Whether or not other information or the latest patient identifying information is contained in the IVRS database is not directly relevant to the present invention. It is the initial creation of the participant record unique identification string 120 and the association with the patient name that is most relevant to the process of the present invention in terms of how the IVRS contributes. Because the general concepts and example implementations of an IVRS are known by those of skill in the art, no additional description regarding such systems is necessary herein.

In general, the patient database 108 will reside at the clinical trial location for patient visits (or at least the interface to the patient database 108, where users can enter, update, or investigate data relating to the patients). Because patients are appearing in person at such locations, their patient identifying information is known to the staff and personnel at those locations. By patient identifying information, what is meant is such information as name, address, phone, email, emergency contact, primary care physician, insurance, date of birth, race, sex, social security number, and the like. Such information is entered into the patient tracking system 106 either by patient directly, or by clinical trial staff.

The patient tracking systems 106 are often configured to generate a participant record unique identification string 120 for each patient of a plurality of patients that visit the clinical trial office location (e.g., doctor's office). The format of the participant record unique identification string 120 is configured in such a way that maintains patient anonymity and does not itself convey patient identifying information upon gaining knowledge of the string itself. What is meant by this is that the participant record unique identification string 120 is a series of letters, numbers, or both, arranged in a unique way, but a way that does not on its face convey patient identifying information, specifically, information that would identify the person/patient. The string of characters would be considered to identify the person/patient if one can tell or could reasonably determine to whom it refers by looking at the participant record unique identification string 120. Common strings that could not be used as a participant record unique identification string 120 could include name, address, and social security number, but may also include date of birth, Zip Code, county location, or the like (in similar fashion to the definition of individually identifiable healthcare information under the Health Insurance Portability and Accountability Act, guidelines). So, while a patient's full name is a string of letters, when arranged as the patient's name the string conveys patient identifying information. As such, a patient's name will not be used as a participant record unique identification string 120. However, other string combinations are possible, such as “patient XY472”, or “patient 577”, or 12238-001. In some conventional systems, the string may include 4 or 5 digits. The first 1-2 relate to the country or geographic location in which the clinical trial is located. The next 2-3 numbers relate to the specific investigator site. The final numbers following a “dash” are one, two, or three digits relating to a specific patient/participant. Strings are often not assigned in sequential order, so as to provide further anonymity measures. Again, the strings are designed so as to never convey name, age, sex, date of birth, or any body of numbers that could allow for triangulation of patient identifying information. As can be readily appreciated, such other string combinations do not, themselves, convey patient identifying information to someone having the knowledge of only these string combinations. As can additionally be readily appreciated by one of skill in the art, the present invention is by no means limited to the particular string combinations described herein. Rather, any appropriate string combination may be utilized as described herein, so long as it does not itself directly convey patient identifying information (as described herein).

The clinical trial participant reimbursement system 100 makes use of the participant record unique identification string 120 by requiring that number be forwarded to the patient recruitment management system 102 and utilized as the identification for a plurality of patient records maintained by the patient recruitment management system 102 and in the patient recruitment management system database 104. That is, the personal and private patient identifying information that resides at the patient tracking system 106 and/or patient database 108 remains only with the patient tracking system 106 and/or patient database 108 (as viewed by the patient recruitment management system; that is, the patient recruitment management system does not have direct access to this information). When a particular patient record is needed at the patient recruitment management system level, all that is required is some form of identifier for a participant record that has data attached to it with respect to treatments, costs, etc. The anonymity of the actual patient that is behind the patient record is maintained because the identity of the patient is not information that is communicated to the patient recruitment management system 102 or the corresponding patient recruitment management system database 104.

For clinical trials where there is a component of participant reimbursement, the clinical trial participant reimbursement system 100 can be utilized and can further include the card management system 110 with the corresponding card management database 112. The card management database 112 can be a single database or multiple databases, as would be appreciated by those of skill in the art. There are numerous different forms of card management system 110 that can be utilized. For example, numerous providers offer systems that allow users to transfer money and receive payments through re-loadable prepaid MasterCard®, Visa®, American Express® debit cards, or the like. One such example is offered by Payoneer of New York, N.Y. The card management system 110 manages all processes relating to activation, loading, re-loading, and all transactions occurring with payment cards, and has a corresponding card management system to manage all such processes. There are many other providers of payment card services, as such the present invention is by no means limited to the named service or card. Likewise, no additional description regarding payment card services is provided herein as they are well understood by those of skill in the art.

The card management system 110 is capable of managing, e.g., loading and reloading payment cards 114 as directed. The card management system 110 does require at least one financial account from which the money used to load the payment cards 114 is supplied to the card management system 110. In accordance with the present invention, the sponsor of the clinical trial is responsible for replenishing the financial account that supplies the money to the card management system 110 for loading onto each payment card 114. Replenishment can be done by the sponsor itself, or by an agent or other entity at the direction of, and on behalf of, the sponsor.

In accordance with the present invention, a plurality of participant records are stored in the patient recruitment management system database 104. Each participant record is stored in association with the participant record unique identification string 120 provided by the patient tracking system 106 for each patient of the plurality of patients. Said differently, the patient recruitment management system 102 and corresponding patient recruitment management system database 104 keep a collection of de-identified participant records. Each participant record correlates to a patient that is participating in the particular clinical trial. However, each participant record does not have information that would readily reveal the identity of the underlying patient it represents (it is de-identified). For purposes of identification of a particular patient, the participant record has only the participant record unique identification string 120. The participant record unique identification string 120 is the manner by which a particular record can be searched and located by the patient recruitment management system 102 and corresponding patient recruitment management system database 104. Should there be a necessity for learning the actual identity of a particular patient, such is only discoverable by accessing the patient tracking system 106 and corresponding patient database 108, providing the participant record unique identification string 120, and locating the patient record. Such actual identity information is not stored in the patient recruitment management system 102.

During the occurrence of the clinical trial, a patient may have need for reimbursement for various expenses that are incurred by the patient as a result of participation in the clinical trial. Such expenses may include, but are not limited to, e.g., mileage, travel, meals, parking, lodging, and the like. Those of skill in the art will appreciate that other expenses can be involved, and are included herein under the general nature of an expense. The sponsor of the clinical trial is responsible for reimbursing allowable expenses. Whether an expense is allowable or not would depend on the terms and conditions of the particular clinical trial, as well as in some instances government rules and regulations, as would be appreciated by those of skill in the art. Different clinical trials can have different terms and conditions with respect to allowable reimbursements and corresponding policies. The present invention is intended for implementation for all such reimbursement policies.

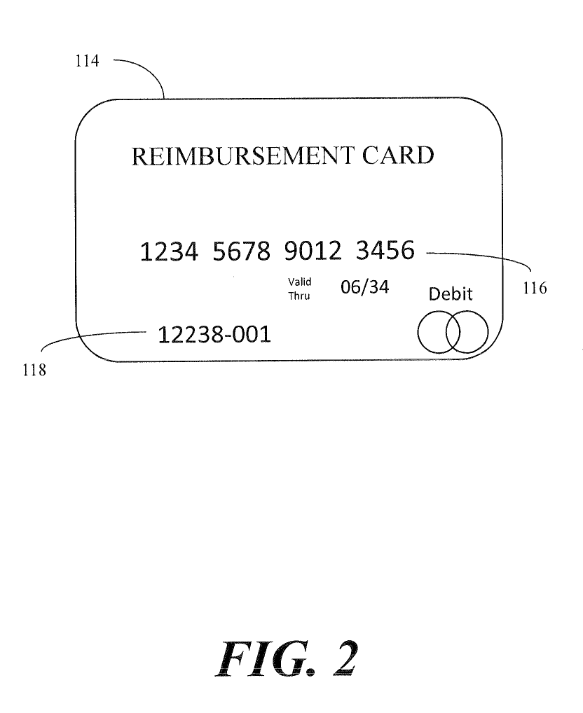

When there is a need for a patient to be reimbursed, the present invention requires that the patient be enrolled and receive a payment card 114. The payment card 114, as shown in FIG. 2, includes a reloadable payment card unique identification string in the form of a standard card number 116 as would be found on all debit cards. In addition, the payment card 114 includes a unique cardholder identification string 118. The unique cardholder identification string 118 can exactly match the participant record unique identification string 120 stored in the patient recruitment management system database 104 of the patient recruitment management system 102. Alternatively, as would be appreciated by those of skill in the art, the patient recruitment management system 102 can generate an additional unique identification string to provide to the card management system 110 and create an association in the patient recruitment management system database 104 between the additional unique identification string and the participant record unique identification string 120 provided by the patient tracking system 106. In either instance, the end result is that a unique identification string is associated with, and placed on, the payment card 114 for the particular patient, and that string does not in and of itself reveal the patient identifying information (e.g., name, etc.). For purposes of further explanation herein, the illustrative embodiment described is one where the unique cardholder identification string 118 exactly matches the participant record unique identification string 120. In actual implementations, it is more likely that a different string is utilized and associated with the unique cardholder identification string 118; however, such added complexity is not necessary to explain the present invention.

There can be a plurality of payment cards 114 allocated to a clinical trial via the patient recruitment management system 102. Each payment card is activated, loaded, re-loaded, and otherwise managed by the card management system 110 as any payment card (e.g., debit card) is implemented.

Within the patient recruitment management system database 104 of the patient recruitment management system 102, each of the plurality of reloadable payment card unique identification strings can be stored in association with each of the participant record unique identification string 120s. Said differently, there is a reloadable payment card unique identification string for each card. The reloadable payment card unique identification string is stored in association with the participant record unique identification string 120s in the patient recruitment management system database 104 in a manner that associates one with the other in such a way that a particular payment card 114 can be linked to a particular participant in the patient recruitment management system database 104. Because the patient recruitment management system database 104 and the patient recruitment management system 102 do not contain the patient identifying information, there is no revelation of the patient identifying information with respect to the particular payment card 114. The patient anonymity is maintained. The payment cards 114 are identity neutral.

When the reloadable payment card requires loading or reloading of monetary funds, a request can be put into the patient recruitment management system 102. The request must include the participant record unique identification string 120s, which is how the participants are tracked in the patient recruitment management system 102, and it should also include some indication of amount. That indication of amount can be a communication of a particular activity for which a pre-set dollar value is assigned, or can be an indication of e.g., a tier or category of reimbursement for which a pre-set dollar value is assigned, or can be an indication of an actual dollar value, or the like. Those of skill in the art will appreciate that the amount indication need only be in the form necessary as agreed to when a particular clinical trial is set up, such that by including that indication the patient recruitment management system 102 is able to communicate a dollar value to the card management system 110. Those of skill in the art will additionally appreciate that “dollar” is representative of a form of monetary unit; however, the present invention is by no means limited to implementation with the US Dollar, but can use any agreed upon currency.

The participant record unique identification string 120 enables the patient recruitment management system 102 to locate the participant record. Because the plurality of reloadable payment card unique identification strings are stored in association with each of the participant unique identification strings in the patient recruitment management system database 104, the patient recruitment management system 102 is able to identify the particular payment card 114 that requires loading of a dollar value. As such, loading of a reloadable payment card 114 can be effected upon receipt by the patient recruitment management system 102 of an instruction containing only the participant record unique identification string 120 and an indication of amount. The patient recruitment management system 102 locates the reloadable payment card unique identification string and then can out put an instruction to the card management system 110 with the reloadable payment card unique identification string and the dollar amount to be loaded onto the payment card 114.

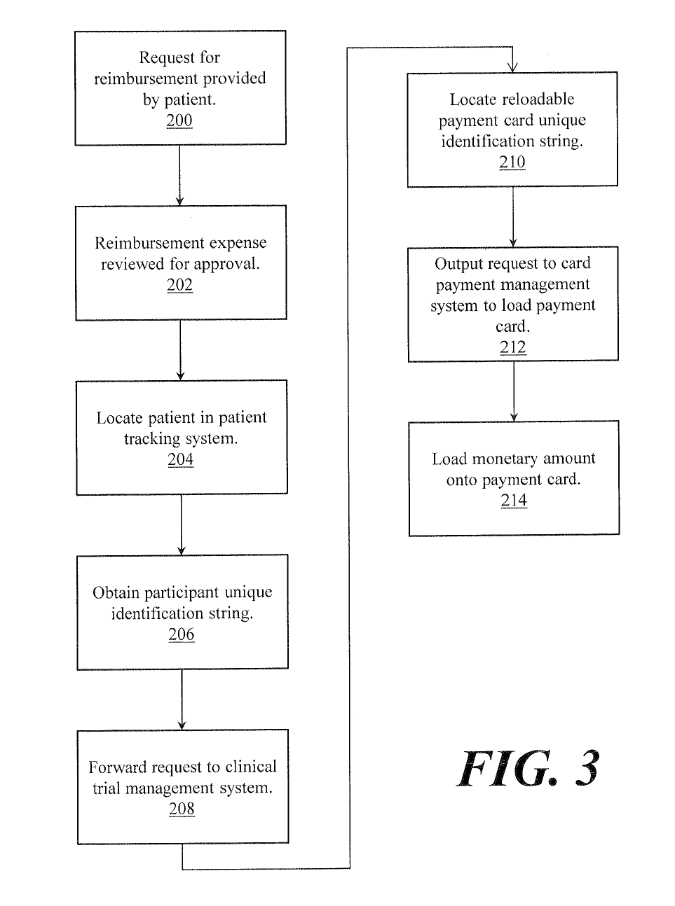

Turning to FIG. 3, in operation, the clinical trial participant reimbursement system 100 manages and effects loading of monetary value onto desired payment cards 114 for a particular participant/patient in a clinical trial without requiring patient identifying information. That is, patient identifying information is not required to load a particular payment card 114. An example methodology can be as follows. The patient arrives at the clinical trial location and provides a receipt for a reimbursable expense (step 200). Someone at the clinical trial location reviews the receipt and approves the reimbursable expense (step 202). The patient is located in the patient tracking system 106 (e.g., in the patient database 108) (step 204). The participant record unique identification string 120 associated with that patient is obtained from the patient tracking system 106 (step 206). Using the participant record unique identification string 120, a request is placed with the patient recruitment management system 102 including the participant record unique identification string 120 and an amount for reimbursement (step 208). Alternatively, a request can be forwarded from the patient tracking system 106 to the patient recruitment management system 102 with the participant record unique identification string 120 and an amount for reimbursement. The patient recruitment management system 102 receives the request and locates the reloadable payment card unique identification string associated with that participant record unique identification string 120 in the patient recruitment management system database 104 (step 210). The patient recruitment management system 102 then outputs a request to the card management system 110 with the reloadable payment card unique identification string and the amount to be loaded onto the payment card 114 (step 212). The card management system 110 receives the request and loads the requested dollar value onto the payment card 114 (step 214), drawing from a financial account funded by the sponsor of the clinical trial. The dollar value or dollar amount can be fixed at a pre-determined amount, or can be variable/customized, as desired. The method can be repeated to re-load the payment card 114 as desired.

It should be noted that the payment card 114 can be initially dispatched to the patient with a zero balance, and the loading process can then be implemented. As such, the payment cards 114 can be stored without added security requirements at the clinical trial location (e.g., doctor's office) or anywhere, without concern of them being lost or stolen (with a zero balance, they have no cash value).

It should also be noted that the clinical trial participant reimbursement system 100 is capable of accounting for, and addressing, issues such as lost payment cards 114. For example, should a patient lose their payment card 114 but not know the card number. The patient can contact the clinical trial location (e.g., doctor's office) and report the lost card. The patient tracking system 106 can be accessed and a notification sent with the participant record unique identification string 120 to the patient recruitment management system 102 indicating a lost card for that participant. The notification can be sent directly by the patient tracking system 106, or can be sent directly to the patient recruitment management system 102 by a user. The patient recruitment management system 102 can notify the card management system 110, using the reloadable payment card unique identification string, that the card has been lost. The card management system 110 can, if desired, look up the remaining balance amount on that lost payment card 114, deactivate the card, and record/activate a new card with the came remaining balance. The new card information can then be passed back to the patient recruitment management system 102 for updating in the patient recruitment management system database 104 in association with the participant record unique identification string 120 (e.g., associating the participant record unique identification string 120 with the reloadable payment card unique identification string). Alternatively, a new card activation process can be initiated the same way the original card was initiated, and the balance amount can be placed on the new card, as would be appreciated by those of skill in the art. The new replacement card can be generated and activated in a number of different ways. An important aspect of the present invention is that the balance on the lost or damaged card is traceable by the system of the present invention, and a replacement card can be issued with the same balance that was remaining on the previous lost or damaged card, with the lost or damaged card being further deactivated to avoid someone accessing the remaining balance inappropriately.

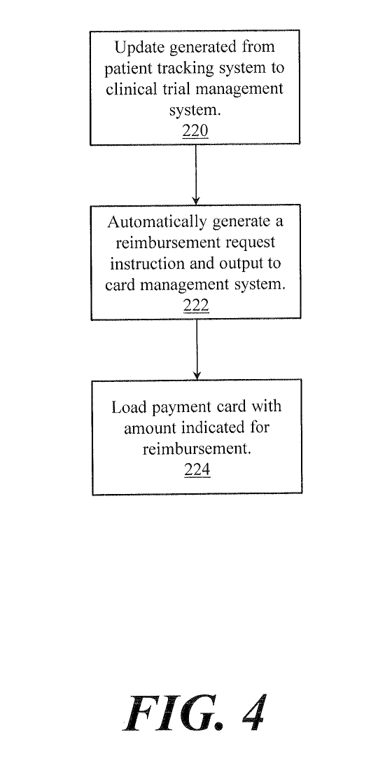

It should further be noted that the method of loading the payment card 114 can be implemented essentially automatically once the payment card 114 is activated and on record in the necessary systems. For example, looking at FIG. 4, the patient tracking system 106 can provide recurring updates to the patient recruitment management system 102 as information changes or events occur. The clinical trial participant reimbursement system 100 can be configured in such a way as to automate the process of reimbursing a payment card 114. Specifically, with each update from the patient tracking system 106, the patient recruitment management system can either receive an indication of a reimbursable expense or determine a standard reimbursable amount (e.g., from a lookup table) and issue the instruction to the card management system 110 to load the payment card 114 with the desired amount. This process can be implemented in an automated fashion. The process may occur as follows. The patient tracking system 106 provides a participant update to the patient recruitment management system 102 (step 220). The patient recruitment management system 102 automatically generates a reimbursement request instruction, based on the update, and outputs the request instruction to the card management system 110 with the desired reimbursement amount (step 222). The card management system 110 loads the payment card 114 with the amount indicated (step 224). As would be appreciated by those of skill in the art, the particular amount may vary and be set, e.g., per visit, per location, per patient, or using any number of criterion to set the amount in an automated fashion.

An appropriately configured computing device or devices can be used to implement the clinical trial participant reimbursement system 100 and the methods described herein. For example, such computing devices generally can include a personal computer, a workstation computer, a laptop, a desktop, a hand-held device, a mobile device, a cellular device, a smartphone device, a tablet computer, a palmtop computer, a set top box, or any other computing device, as would be understood by those of skill in the art. Embodiments of the present invention may utilize any number of computing devices in any number of different ways. Accordingly, embodiments of the present invention are not limited to a single type of implementation or configuration of the example computing device.

The computing device can include a bus that can be coupled to one or more of the following illustrative components, directly or indirectly: a memory, one or more processors, one or more presentation components, input/output ports, input/output components, and a power supply. One of skill in the art will appreciate that the bus can include one or more busses, such as an address bus, a data bus, or any combination thereof. One of skill in the art additionally will appreciate that, depending on the intended applications and uses of a particular embodiment, multiple of these components can be implemented by a single device. Similarly, in some instances, a single component can be implemented by multiple devices.

The computing device can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device.

The memory can include computer-storage media in the form of volatile and/or nonvolatile memory. The memory may be removable, non-removable, or any combination thereof. Exemplary hardware devices are devices such as hard drives, solid-state memory, optical-disc drives, and the like. The computing device can include one or more processors that read data from components such as the memory, the various I/O components, etc. Presentation component(s) present data indications to a user or other device. Exemplary presentation components include a display device, speaker, printing component, vibrating component, etc.

The I/O ports can allow the computing device to be logically coupled to other devices, such as I/O components. Some of the I/O components can be built into the computing device. Examples of such I/O components include a microphone, joystick, recording device, game pad, satellite dish, scanner, printer, wireless device, networking device, and the like.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A clinical trial participant reimbursement system, comprising:
a patient recruitment management system comprising a patient recruitment management system database storing each of a plurality of reloadable payment card unique identification strings in association with a different participant record unique identification string, the participant record identification string maintaining patient anonymity by not containing a combination of string characters that communicates patient identifying information;
wherein loading of a reloadable payment card is effected upon receipt by the patient recruitment management system of an instruction to load a reloadable payment card, the instruction only requiring the participant record unique identification string and an indication of amount, and the patient recruitment management system.

2. The system of claim 1, wherein the instructing reloading of the reloadable payment card comprises the patient recruitment management system generating and outputting an instruction to a card management system, the instruction containing the reloadable payment card unique identification string associated with the participant record unique identification string and the indication of amount.

3. The system of claim 1, wherein the indication of amount comprises a selected quantity of monetary value.

4. The system of claim 1, wherein patient identifying information is not required by the patient recruitment management system to effect loading of the reloadable payment card.

5. The system of claim 1, wherein patient identifying information is not required by a card management system to effect loading of the reloadable payment card.

6. The system of claim 1, wherein the reloadable payment card remains reloadable after having been dispatched to a participant.

7. The system of claim 1, wherein the reloadable payment card is dispatched to a participant with a zero cash value, a pre-determined value, or a customized value.

8. The system of claim 1, wherein a clinical trial sponsor funds a financial account that supplies the reloadable payment card with money.

9. A clinical trial participant reimbursement system, comprising:
a patient tracking system having a patient database, the patient database storing a plurality of participant record unique identification strings, one string for each patient of a plurality of patients, the participant record unique identification string configured in such a way that maintains patient anonymity and does not itself convey patient identifying information;
a patient recruitment management system having a patient recruitment management system database;
a plurality of participant records stored in the patient recruitment management system database, each participant record stored in association with the participant record unique identification string provided by the patient tracking system for each patient of the plurality of patients;
a card management system having a card management system database;
a plurality of reloadable payment cards managed by the card management system;
a plurality of reloadable payment card unique identification strings stored in the card management system database, each reloadable payment card unique identification string stored in association with one of the plurality of reloadable payment cards;
wherein, within the patient recruitment management system database, each of the plurality of reloadable payment card unique identification strings stored in association with each of the participant record unique identification strings;
wherein loading of a reloadable payment card is effected upon receipt by the patient recruitment management system of an instruction containing only the participant record unique identification string and an indication of amount.

10. The system of claim 9, wherein the instruction to load the reloadable payment card causes the patient recruitment management system to generate and output an instruction to the card management system, the instruction containing the reloadable payment card unique identification string associated with the participant record unique identification string and the indication of amount.

11. The system of claim 9, wherein the indication of amount comprises a selected quantity of monetary value.

12. The system of claim 9, wherein patient identifying information is not required by the patient recruitment management system to effect loading of the reloadable payment card.

13. The system of claim 9, wherein patient identifying information is not required by the card management system to effect loading of the reloadable payment card.

14. The system of claim 9, wherein the reloadable payment card remains reloadable after having been dispatched to a participant.

15. The system of claim 9, wherein the reloadable payment card is dispatched to a participant with a zero cash value, a pre-determined value, or a customized value.

16. The system of claim 9, wherein a clinical trial sponsor funds a financial account that supplies the reloadable payment card with money.

17. The system of claim 9, wherein the patient database comprises a patient interactive voice response system (IVRS) database containing patient identifying information in association with each of the plurality of participant record unique identification strings.

18. The system of claim 9, wherein each of the plurality of participant record unique identification strings is configured to maintain patient anonymity.

19. A method of automatically effecting loading a reloadable payment card with a reimbursement amount, the method comprising:
a patient recruitment management system receiving an update from a patient tracking system regarding activity relating to a clinical trial participant;
the patient recruitment management system automatically generating a reimbursement request instruction based on the update; and
the patient recruitment management system outputting the reimbursement request instruction including an amount of monetary value to a card management system.

20. The method of claim 19, further comprising the card management system receiving the reimbursement request instruction and loading the amount of monetary value onto a payment card issued to the clinical trial participant.
